(19) United States
(12) Patent Application Publication
(10) Pub. No.: US 2019/0168359 A1
(43) Pub. Date: Jun. 6, 2019

(54) SEPARATING BLADE FOR PROCESSING A HARD MATERIAL, AND TOOL

(71) Applicant: LISSMAC MASCHINENBAU GMBH, Bad Wurzach (DE)

(72) Inventor: Martin LEISING, Leutkirch (DE)

(73) Assignee: LISSMAC MASCHINENBAU GMBH, Bad Wurzach (DE)

(21) Appl. No.: 16/257,517

(22) Filed: Jan. 25, 2019

Related U.S. Application Data
(63) Continuation of application No. PCT/EP2017/069842, filed on Aug. 4, 2017.

(30) Foreign Application Priority Data
Aug. 11, 2016 (DE) 10 2016 114 871.7

(51) Int. Cl. B24D 5/10; B28D 1/04

(52) U.S. Cl. CPC B24D 5/10; B28D 1/045

(57) ABSTRACT

The proposal is for a separating blade for the material-removing machining of a mineral-containing hard material, wherein the separating blade is designed to be set in rotation by means of a drivable flange arrangement, and wherein a liquid coolant can be supplied to the separating blade for a machining mode. According to the invention, in an inner volume of the separating blade that is surrounded by parts of the separating blade, an inner structure for providing a flow path, through which the coolant can flow, between an inlet point and an outlet point is formed in such a way that, in the connected state with the flange arrangement, an outflow of portions of the supplied coolant from the inner volume is prevented along the flow path during the machining mode of the separating blade, thus ensuring that no coolant reaches the machining section on the outside of the separating blade.

### CROSS REFERENCE TO RELATED APPLICATIONS

This application is a continuation of International Application No. PCT/EP2017/069842 filed Aug. 4, 2017, which designated the United States, and claims the benefit under 35 USC § 119(a)-(d) of German Application No. 10 2016 114 871.7 filed Aug. 11, 2016, the entireties of which are incorporated herein by reference.

### FIELD OF THE INVENTION

The present invention relates to a separating blade for processing a hard material, and a tool.

### BACKGROUND OF THE INVENTION

Separating blades such as sawblades or joint cutting disks for the machining, in particular cutting, of materials such as concrete, asphalt or stone are known, as are corresponding tools, e.g. mobile joint cutters.

The tools are designed as cutting and separating devices for the material-removing machining of mineral-containing hard materials, wherein the separating blade is driven at a high speed of rotation with the aid of a flange arrangement that engages thereon.

In road or airport construction, for example, the material of the traffic surfaces is machined or cut with joint cutters in order to access areas under the traffic surface, e.g. to enable pipes to be laid in the subgrade. The mechanical and thermal loads which arise at the separating blade are relatively high in continuous operation and make cooling absolutely essential. For cooling or lubricating separating blades and for carrying away the material removed by the separating blade, water is used, for example.

Significant secondary problems occur in connection with coolants used in operation, especially in continuous operation of the tool, necessitating countermeasures which, in turn, entail new problem areas.

The technical and economic requirements on the separating blades and the associated tools are becoming ever more complex in practice. Hitherto, it has not been possible to find a solution to the problem which is practical or meets all the requirements for all applications.

### SUMMARY OF THE INVENTION

It is the object of the present invention to make available a separating blade or a tool of the type stated at the outset which can be used to technical and economic advantage for a very wide variety of machining tasks for the material-removing machining of mineral-containing hard materials. The intention is, in particular, to make available a joint-cutting separating blade or a sawblade for construction machines for use on large-scale construction sites.

The present invention starts from a separating blade for the material-removing machining of a mineral-containing hard material, comprising a machining section, situated radially on the outside with respect to a central separating blade axis, for material removal of the hard material, wherein the separating blade is designed to be set in rotation by means of a drivable flange arrangement, and wherein a liquid coolant can be supplied to the separating blade for a machining mode.

The flange arrangement can be connected in the region around the separating blade axis to the disk-shaped separating blade, comprising, in particular, a flange section on both sides of the separating blade, wherein a connection is made on both sides of the separating blade by clamping or screw-fastening means. The machining section comprises hard materials, preferably a diamond material and/or an ultrahard metal, for example.

The terms “axial” and “radial” below refer to the separating blade axis.

A first aspect of the present invention consists in that, in an inner volume of the separating blade that is surrounded by parts of the separating blade, an inner structure for providing a flow path, through which the coolant can flow, between an inlet point of the separating blade for supplying the coolant and an outlet point of the separating blade for the discharge of the coolant is formed in such a way that, in the connected state with the flange arrangement, an outflow of portions of the supplied coolant from the inner volume is prevented along the flow path during the machining mode of the separating blade, thus ensuring that no coolant reaches the machining section on the outside of the separating blade.

Instead of coolant, the term cooling liquid is also used as a synonym below.

Liquid cooling, which is more effective than air cooling, for example, is thereby made available as internal cooling or as cooling with cooling liquid carried exclusively in the interior. Conversely, cooling liquid is kept away from the outside of the separating blade, this being advantageous over operation with cooling liquid present on the outside. According to the present invention, the separating blade remains absolutely dry on the outside, ensuring that the removal of the mineral-containing hard material by machining takes place in the dry state or in the dry working mode. There is no need for a supply of coolant on the outside of the separating blade.

In the case of separating blades that are operated wet, the quantities of liquid required on the outside of the separating blade are such that the work environment or subgrade, generally a sand or gravel subgrade or earth, below the ground material to be removed, such as a carriageway surface consisting of asphalt or concrete, is washed away by the draining or accelerated cooling liquid, and this is absolutely unwanted in most cases. This is because the remaining areas to the side of the joint cut into the ground material are undermined, as a result of which the ground material or carriageway can no longer take static loads, and expensive additional work is therefore required.

Moreover, dry cutting operation on the work side has further advantages, such as the elimination of caking on the tool and resulting damage or cleaning work. It is also advantageous that penetration of cooling liquid mixed with abrasive particles into gaps in the associated tool is excluded, something that would otherwise usually lead to the failure of the tool after a short time owing to the friction of the particles in rotary bearing assemblies or in drive-side machine components rotating at high speeds. According to the present invention, a suspension of particles and cooling liquid cannot even form in the first place. On the contrary, the cooling liquid remains in a circuit separated from the material to be machined or from the machining section of the separating blade. According to the present invention, the cooling liquid is not contaminated or is kept away from external areas of the tool.

On the other hand, in the present invention, a liquid cooling system that is advantageous in comparison with an air cooling system, with a relatively high thermal conductivity of the cooling liquid, e.g. water, is used, and thus relatively effective heat dissipation from the separating blade is possible. Here, the components of the separating blade are made from a metal material with good thermal conductivity, thus ensuring adequate cooling via the practically relevant material thicknesses of the components. Internal wetting or flow around the regions or surfaces which delimit the flow path by cooling liquid is therefore sufficient for highly effective continuous cooling of the separating blade and, where appropriate, also of adjoining machine components. Moreover, the cooling liquid is kept in motion or continuously mixed as it flows through, or is discharged after absorption of the heat, while cooler cooling liquid is simultaneously supplied again. The inner structure is configured in such a way that the cooling liquid comes into contact with, in particular flows past, to a sufficient extent all those regions which heat up to a relevant extent during operation. Moreover, the cooling performance of the cooling liquid can also be increased or influenced by changing or increasing the volume flow and/or lowering the temperature at which the cooling liquid enters the inner volume.

The inner structure is preferably chosen in such a way that a relatively large inner surface adjoins or delimits the flow path in a structurally simple way. High heat dissipation through the inner surface wetted by the coolant is thereby achieved overall. The inner surface is in thermally conductive connection with the region of the machining section, in particular in a manner which ensures very good heat conduction, by means of material of the separating blade, in particular by means of a metal material, which has a high thermal conductivity, thus ensuring relatively high heat dissipation from the machining section to the inner surfaces of the inner structure along the flow path.

The separating blade according to the invention is advantageous particularly for applications in which the material to be cut through or ground surface when machining ground or traffic surfaces has a thickness as much as 20 centimeters and above, for example, and/or relatively large sections of many hundred meters at once or in continuous operation are machined or traveled. The separating blade according to the invention preferably has a corresponding larger separating blade diameter of about 300 millimeters, in particular over 400 millimeters, in particular over 600 millimeters, in particular over 800 millimeters, in particular as much as 1000 millimeters and above. Moreover, to achieve this, a relatively high driving power is transmitted to the separating blade in order to drive the separating blade uniformly at speeds of revolution of as much as 2500 revolutions per minute and above in continuous working mode.

According to the present invention, the emergence of the cooling liquid onto the outer surfaces of the separating blade, even in the tiniest amounts, is avoided in an absolutely reliable way. This is advantageous, especially if dry operation is necessary or where even the smallest amounts of liquid on the outside of the separating blade or the machining section are unwanted in operation.

In particular, the separating blade is a dry separating blade or dry sawblade, depending on the work method. After discharge from the interior of the separating blade, all the coolant carried in the interior can advantageously be immediately reused for cooling without the need for processing, e.g. filtering.

The inlet point and the outlet point of the separating blade, wherein a plurality of inlet and/or outlet points is preferably provided, are preferably situated in a region of the separating blade axis or in a region of the separating blade close to the axis. The inlet and outlet point are preferably situated at axially opposite points, separated by a wall section which forms an axially inner or central part of a blade or a disk of the separating blade and belongs to the inner structure, for example.

The at least one inlet point and outlet point are preferably situated in an axial region of the separating blade which is covered by the flange arrangement when the flange arrangement is fitted. In general, the cover refers to a part around the separating blade axis which is circular when viewed in the axial direction, on opposite regions of the separating blade. The area or size of the covered region on one side can differ somewhat from the area on the other side.

According to another aspect of the present invention, in an inner volume of the separating blade that is surrounded by parts of the separating blade, an inner structure for providing a flow path, through which the coolant can flow, between an inlet point of the separating blade for supplying the coolant and an outlet point of the separating blade for the discharge of the coolant is formed in such a way, wherein the inlet point and the outlet point are in a hub region of the separating blade and wherein the inner structure defines a flow path for the coolant that can be supplied, according to which, in the machining mode, the coolant flows radially with respect to the separating blade axis from the inside outwards from the inlet point and wherein the coolant flows radially with respect to the separating blade axis from the outside inwards to the outlet point. Between the first partial flow path of the coolant from radially on the inside to radially on the outside and the final partial flow path of the coolant from radially on the outside to radially on the inside, there can be a plurality of further partial flow paths from the inside outwards or from the outside inwards, depending on the number of main blades or the number of further blades, since the coolant is passed selectively in the axial direction in a meandering fashion through the inner structure, through the separating blade or the inner volume. The first partial flow path is always from the inlet point from radially on the inside outwards and the last partial flow path is always from radially on the outside to radially on the inside to the outlet point.

Optimized cooling is thereby achieved in a technically or structurally advantageous or space-saving manner. The first partial flow path from radially on the inside outwards is preferably separated by a wall of the inner structure with respect to the second partial flow path from radially on the outside inwards. In the separating wall, at the radially outer point, there is preferably a passage from the first side of the wall to the axially opposite second side of the wall. The cooling liquid first of all travels the entire distance to be crossed in the radial direction from the inside outwards along the first partial flow path, and then travels the entire distance to be crossed in the radial direction from the outside inwards. The radially outer point, from which the cooling liquid flows back inwards, is preferably situated radially as far as possible towards the outside within the hollow inner volume. The maximum wetting of the inner surfaces in the radial direction is thereby achieved or predetermined. In this case, the inner wall in the hollow volume, the inner wall extending at a fixed axial position from radially on the inside outwards, divides the hollow volume into two partial volumes separated axially by the wall. In one partial volume, the cooling liquid flows radially outwards from the radially inner inlet point to the passage. Via the passage, the cooling liquid enters the other partial volume and then passes from radially on the outside inwards as far as the outlet point and is discharged from there, e.g. extracted by suction. On the flow path described, it is advantageous if there is at least one passage or a plurality of—preferably circumferentially distributed—axial passages exclusively in the radially outer region for the cooling liquid from the first to the second partial volume.

The rotation of the separating blade during operation has the effect that, superimposed on the radial flow of the cooling liquid towards the outside and back inwards, there is also a flow in the circumferential direction relative to the separating blade axis. Full-area wetting of the surfaces delimiting the flow path in the inner volume of the separating blade is thereby achieved in practice, thus ensuring an effective heat transfer from all the heated regions of the separating blade to the cooling liquid and therefore advantageous cooling of the separating blade. In particular, all the inner surfaces that can be reached by the cooling liquid in the inner volume are also in fact advantageously reached by the forced radial flow guidance and by the circumferential flow guidance imposed by the rotation. Moreover, the cooling liquid is conveyed through the inner volume, in particular by a delivery arrangement such as a pumping and/or suction device for supplying and/or discharging the cooling liquid.

Outside the separating blade, the cooling liquid can advantageously be carried in a closed circuit from the outlet point to the inlet point. As an alternative, an open circuit of the cooling liquid is conceivable, in which the cooling liquid discharged from the outlet point is not recirculated to the inlet point. A partially closed circuit is also conceivable, in which only some of the cooling liquid is recirculated from the outlet point to the inlet point or a discharged partial flow of the cooling liquid which is not recirculated is replaced by fresh cooling liquid.

In principle, it is also possible for there to be two or more axially spaced walls in the inner volume of the separating blade. A plurality of hollow partial volumes is thereby formed in the inner volume of the separating blade, the volumes being connected to one another radially on the inside and/or outside by corresponding passages in the walls, thereby enabling the cooling liquid to flow through all the partial volumes in the axial and the radial direction. The inner structure is preferably configured in such a way that a meandering flow path for the cooling liquid is provided in the axial direction. The flow paths are specified in such a way that each partial volume extends to the maximum extent in the radial direction in the separating blade. Moreover, all the partial volumes are fully supplied with the coolant.

It is furthermore advantageous if the inlet point is situated on a first side of the separating blade, and the outlet point is situated on a second side of the separating blade, wherein the first side and the second side lie opposite one another in the axial direction with respect to the separating blade axis. A flow of cooling liquid through the separating blade in the axial direction is thereby predetermined. The inlet point and the outlet point preferably lie axially opposite one another, in particular on a common axis which is offset slightly parallel to the separating blade axis.

It is also advantageous if the inlet point and the outlet point are connected to one another via the flow path for the coolant. This enables the coolant to be forced to pass through the separating blade via the predetermined flow path. The flow along the flow path is assisted by an applied pressure difference between the inlet and the outlet point, for example. In general, no other paths than the flow path are provided for the coolant in the interior or in the hollow volume. It is preferable if all the cavities in the interior of the separating blade form part of the flow path.

Moreover, the flow path ensures that the coolant always flows in the flow direction from the inlet point to the outlet point, i.e. that there is always effective heat dissipation from the separating blade.

Dead flow regions in the inner volume of the separating blade are avoided by means of the inner structure, that is to say those regions in which the coolant is stationary or nondirectional, e.g. flows backwards and forwards or not specifically to the outlet point. Heat transfer from the inner surfaces of the inner volume of the separating blade to the coolant is always to the flowing coolant, thereby excluding local overheating of the separating blade or heat concentrations. Heated coolant is always carried away from the inlet point to the outlet point in the flow direction. The quantity of coolant discharged by the outlet point is replaced or replenished by the corresponding quantity of coolant supplied by the inlet point. The inlet temperature of the coolant supplied at the inlet point is chosen so that it is below the outlet temperature of the coolant discharged at the outlet point.

The flow path is predetermined by means of the inner structure in such a way that the coolant flows past internally adjacent or proximate inner surfaces, preferably in the regions of the separating blade which heat up particularly strongly during operation or which are close to the machining section. The flow path is therefore advantageously configured in such a way that the coolant flows as far as possible radially outwards or as far as inner surfaces which are adjacent to the machining section. In addition, it is advantageous if the flow path passes close to the outside diameter of the separating blade in the radially outer region of the inner volume, thus ensuring that coolant is guided radially outwards along at least most of the extent of the entire circumference. Accordingly, it is advantageous if the hollow inner volume through which flow can occur or the flow path extends close to the outer radius of the separating blade since it is there that the machining section is situated, at which the maximum heat generation occurs due to friction with the material to be cut.

It is furthermore advantageous if guide sections for defining a flow direction of the coolant through the separating blade are formed in the inner volume. The guide sections, e.g. flat or contoured inner surfaces, are preferably configured in such a way that all the inner regions or inner surfaces of the separating blade can be reached and wetted by the cooling liquid or impinged upon by the flow of the cooling liquid.

In particular, the guide sections have the effect that the coolant is guided circumferentially over the entire periphery in a radial direction from the inside outwards and back inwards and radially outwards.

Another advantage can be seen in the fact that there are one or more seals for the fluidtight separation of the inner volume from the outside in a radially outer region of the separating blade. Escape to the outside, even of only the smallest quantities of the coolant, is thereby reliably prevented. A ring seal which is circumferentially closed relative to the separating blade axis is preferably provided, e.g. circumferentially continuous ring seals between the main blade and the respective outer blade or on both sides of the precisely one main blade. The ring seals seal the inner volume radially with respect to the outside and, accordingly, rest in an absolutely leaktight manner against the opposite annular regions on the main blade and on the outer blade. In the case of flexible or rubber-like ring seals, these are compressed or squeezed somewhat, for example.

An advantageous modification of the subject matter of the present invention is characterized in that the guide sections delimit the flow path, wherein the flow path has a section with an axial extent with respect to the separating blade axis. In particular, the axial extent of the flow path in a region which is radially on the outside relative to the separating blade axis or is close to the machining section forms a passage for coolant through an inner wall in the inner volume of the separating blade, with the result that, after passing through the passage, the coolant can flow back radially inwards on the other side of the inner wall. In the case of a plurality of axially offset inner walls, there can also be an axial passage for coolant through an inner wall in a radially inner region.

An advantageous variant of the present invention consists in that the separating blade has a main blade and two outer blades, wherein the main blade is situated between the two outer blades in the axial direction of the separating blade. The main blade has a machining section, but the outer blades do not. It is thereby possible to provide the separating blade in an economical and technically advantageous manner.

The separating blade according to the present invention is preferably of multi-layer construction, comprising a plurality of individual disk-shaped blades, which are aligned parallel to one another and connected firmly in a releasable manner to one another, being screwed together for example. All the blades or individual blades have a machining section.

In the text which follows, the main blade, outer blade and intermediate blade should be taken to mean blades which extend over most of the radius of the separating blade or have a common central blade axis. In particular, spacer disks serving as spacers, in the form of washers around screw-fastening means of screwed joints, which pass through the blades and connect them firmly to one another, wherein the spacer disks are situated between the blades, should not be taken to be main, outer and intermediate blades. The spacer disks have a much smaller diameter than a main, outer and intermediate blade.

Preferably, there is precisely one main blade and precisely two outer blades, thereby providing a single separating blade or a single tool. The precisely three blades connected firmly to one another are each disk-shaped with opposite flat sides, for example. In the axial direction, the three blades are situated next to one another and form a sandwich structure with the axially central main blade, which has the machining section, and the two outer blades without a machining section. Accordingly, there is an outer blade aligned parallel to the main blade on each side of the main blade. Between the respective outer blade and the main blade there is an axial clearance, which forms a respective part of the hollow inner volume or flow path, through which the coolant can flow. To form the clearance between the blades, there are preferably spacers.

On the outer circumference, the main blade has the machining section, wherein the machining section projects radially beyond the outer radius of the outer blades. The larger radius of the main blade relative to the radius of the outer blades is preferably due solely to the machining section. In this case, the machining section is preferably of an axial width such that the machining section projects axially somewhat beyond the respective axial outer side of the two outer blades, e.g. in the millimeter range. Frictional contact between the outer blades and the opposite walls of the joint in the mineral-containing hard material which is formed by the separating blade in the separating mode is thereby avoided. This is because the width of the joint corresponds to the axial width of the machining section, which is greater than the axial width between the opposite outer sides of the outer blades.

A modified separating blade according to the present invention advantageously has a plurality of main blades and in each case one intermediate blade between two adjacent main blades.

The separating blade preferably has precisely two main blades positioned axially on the outside, each having a circumferential machining section, and precisely one intermediate blade without a machining section between the two main blades. This represents a double separating blade or double tool according to the present invention.

The intermediate blade has a comparatively slightly smaller diameter than the two main blades of equal diameter. Between the intermediate blade and the respective main blade there are spacers, with the result that a hollow inner volume for the coolant to flow through in a manner that is leaktight with respect to the outside is in each case formed between the three blades. Both main blades are thus cooled over the full area on the inside as the coolant flows past. In this case, the main blade, on which the inlet point is situated, is wetted on the inside by coolant which flows radially from the inside to radially on the outside.

Owing to the leaktight delimitation with a ring seal, all the coolant flows 100 percent through passages in the intermediate blade, preferably through a plurality of circumferentially spaced holes in the radially outer region of the intermediate blade. On the other side of the intermediate blade, the coolant flows from radially on the outside to radially on the inside and, during this process, flows over the full area of the other main blade on the inside. At this main blade, the heated coolant is discharged via the outlet point.

Alternatively, a construction derived from the abovementioned construction is possible, in which there is also a machining section on the intermediate blade, wherein the outside diameter of all three disks is the same to ensure that the machining sections extend as far as an identical radius. Instead of the intermediate blade, a third main blade is used, for example, but, unlike the two outer mutually identical main blades, which do not have any holes in the radially outer region, this has circumferentially spaced passages or holes for the flow path of the coolant in the radially outer region.

Accordingly, it is advantageous if the separating blade has a plurality of main blades without an intermediate blade between two adjacent main blades. There is therefore no intermediate blade that has no machining section. For a comparable axial width, the separating blade thus becomes even more effective, this being due to the additional machining section over an arrangement with an intermediate blade.

A triple separating blade or triple tool is thereby advantageously provided, which has a longer service life than a single or a double tool.

It is also advantageous if there are one or more seals in a radially outer region and in an axial intermediate region between a main blade and an axially adjacent blade of the separating blade. The seal, e.g. a sealing ring, seals the inner volume with respect to the outside, in particular fluidtightly and in a circumferentially closed manner. The seal reliably avoids coolant escaping along the flow path. As a result, no coolant can reach the outside of the separating blade, which is free with respect to the environment. A separating blade is designed as a separating blade that operates dry.

It is furthermore advantageous if the separating blade has a separating blade diameter of over 300 millimeters. The separating blade preferably has a separating blade diameter of over 400 millimeters, preferably of over 600 millimeters, preferably of over 800 millimeters and preferably of over 1000 millimeters. The separating blade according to the present invention can thus advantageously be used for comparatively large machining depths in continuous operation. In particular, the separating blade is of practical use for civil engineering, on large-scale construction sites and external areas and for relatively long machining lengths. The separating blade according to the present invention is preferably designed for use on driven mobile construction machines, such as joint cutters for road construction.

It is furthermore advantageous if there is a spacer element between two adjacent blades of the separating blade. There is preferably a spacer element between a main blade and an outer blade and/or an intermediate blade of the separating blade. By means of a spacer element or a spacer, e.g. a spacing washer, precise positioning and spacing of the disks relative to one another can be made possible. By means of the spacing formed between the relevant blades of the separating blade, the hollow inner volume and hence the flow path for the coolant are formed. It is advantageous if the spacer element is provided in the region around a screw opening passing axially through the separating blade for mounting the separating blade on a flange arrangement. There is preferably a plurality of spacer elements, and these furthermore effect mechanical stabilization or stiffening of the separating blade under mechanical loading by forces and torques. There is preferably a plurality of spacer elements distributed over a radius of the separating blade.

The present invention furthermore extends to a tool having a flange arrangement for a separating blade that can be driven in rotation, in particular a joint cutter having a separating blade, wherein there is a separating blade in accordance with one of the abovementioned embodiments. The cooling liquid is preferably supplied to the separating blade via a line in the flange arrangement, the line being closed leaktightly with respect to the outside or being internal, preferably in a closed line system, i.e. without the cooling liquid escaping or being able to escape to the outside in the region of the flange arrangement of the separating blade.

In particular, the tool is provided with a liquid cooling device, in particular, with a water cooling device, e.g. as a driven mobile construction machine for use on large-scale construction sites, having a continuously operating liquid cooling device. The liquid cooling device supplies the coolant to the coolant inlet point of the separating blade and extracts the coolant from the coolant outlet point of the separating blade, e.g. by means of a corresponding liquid pumping device. In this case, the coolant can be carried in an open, a closed or a partially open flow circuit. In all operating modes, the coolant or cooling liquid is supplied to the flange arrangement and the separating blade and carried away therefrom in a liquid-tight manner with respect to the outside, ensuring that the separating blade removes the mineral material to be removed in the dry mode.

### BRIEF DESCRIPTION OF THE DRAWINGS

Further features and advantages of the present invention are explained in greater detail by means of different illustrative embodiments according to the present invention.

FIG. 1 shows a sectioned part of a schematically illustrated tool having a separating blade according to the present invention, which is connected to a flange arrangement of the tool;

FIG. 2 shows the separating blade according to the present invention as per FIG. 1 in a plan view;

FIG. 3 shows a section through the separating blade according to line A-A in FIG. 2;

FIG. 4 shows a section through the separating blade according to line B-B in FIG. 3;

FIG. 5 shows another separating blade according to the present invention in plan view;

FIG. 6 shows a section through the separating blade according to line C-C in FIG. 5;

FIG. 7 shows a section through the separating blade according to line D-D in FIG. 6;

FIG. 8 shows another separating blade according to the present invention in plan view;

FIG. 9 shows a section through the separating blade according to line E-E in FIG. 8; and

FIG. 10 shows a section through the separating blade according to line F-F in FIG. 9.

### DETAILED DESCRIPTION OF THE INVENTION

In some cases, the same reference signs are used below for corresponding elements of different illustrative embodiments of the present invention.

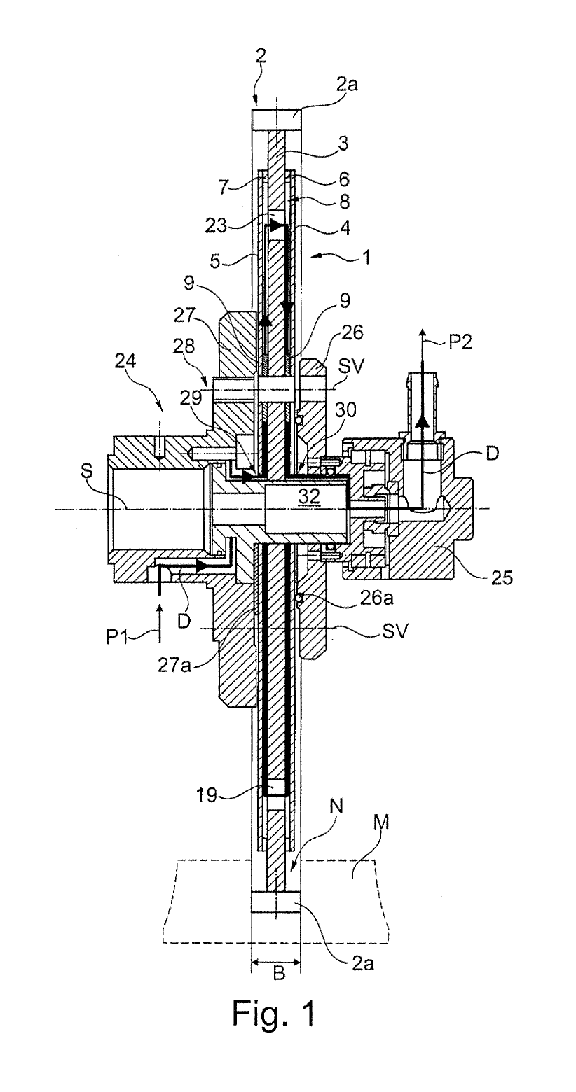

FIG. 1 shows, in highly schematized form, a flange arrangement 24 having a separating blade 1 according to the present invention in section along a diameter of the separating blade 1. The separating blade 1 is designed as an internally cooled single tool or as an internally cooled single sawblade, which is used for the material-removing machining or cutting of a hard ground material M, such as a concrete, asphalt or stone material, a section of which is indicated in dashed lines in FIG. 1.

The separating blade 1 can be driven in rotation about its separating blade axis S, which is illustrated in extended form. The following indications “radial” and “axial” relate to the separating blade axis S.

Radially on the outside or on an outer rim, the separating blade 1 furthermore has a machining section 2, which is illustrated as circumferentially continuous and, in this case, comprises a diamond tool 2a with the axial width B, for example. By means of the rotating separating blade 1, a joint or a groove N with the width B corresponding to the width B of the machining section 2 can be introduced into the ground material M.

The separating blade 1, which is a three-ply blade in the embodiment illustrated, has precisely one main blade 3 and two outer blades, which are designed as cover plates 4 and 5, wherein the main blade 3 is situated centrally between the two outer blades in the axial direction or with an equal axial spacing with respect to each of the two cover plates 4, 5 (see FIG. 3).

The main blade 3 and the two cover plates 4, 5 are connected to one another and are held at an axial spacing between the main blade 3 and the cover plates 4 and 5 by means of six spacing washers 9 to 14 between the main blade 3 and cover plate 4 and by means of six spacing washers 9 to 14 between the main blade 3 and cover plate 5. The respective intermediate regions of the respective axial spacing forms an inner volume 8 of the separating blade 1, wherein the axial spacing can be specified by means of the thickness of the spacing washers 9 to 14. By means of the spacing washers 9-14, the main blade 3 and the two cover plates 4, 5 can be firmly connected to one another, e.g. by material bonding.

In a region of the separating blade 1 or of the blades 3, 4 and 5 which is close to the axis or central, there is in each case an axial through hole 15 through the separating blade 1 in alignment with a respective central opening in each spacing washer 9 to 14. By means of screwed joints 28 through the six through holes 15 distributed circumferentially on a radius, the separating blade 1 can be firmly connected to flange parts 26 and 27 of the flange arrangement 24, which engage on both sides of the separating blade 1. A rotary union 25 that is stationary with respect to the flange part 26 adjoins the flange part 26.

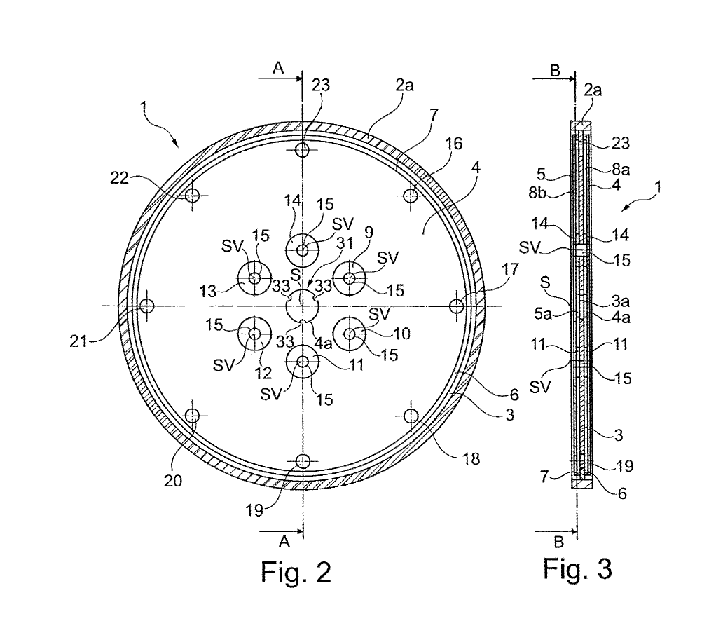

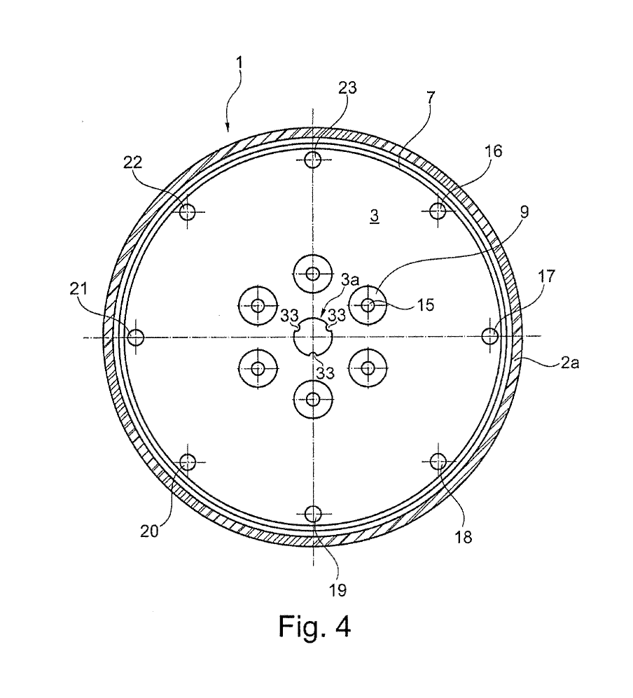

Screw-fastening means (not shown) of the screwed joints 28 pass through the through holes 15 and corresponding openings in the flange arrangement 24, wherein the screwed-joint axes SV are indicated in FIGS. 2 and 3.

The flange parts 26 and 27 make fluidtight contact with the outer surfaces of the cover plates 4 and 5, e.g. with the aid of seals 26a and 27a.

The hollow inner volume 8 formed in the interior of the separating blade 1, through which a liquid coolant such as water can flow, comprises a disk-shaped first partial volume 8a between cover plate 4 and the main blade 3 and a disk-shaped second partial volume 8b between cover plate 5 and the main blade 3. During the operation of the separating blade 1, the coolant is supplied to the flange part 27 and hence to an inlet point 29 on the separating blade 1, in particular continuously in supply direction P1, and, after flowing through the inner volume 8 in the outlet direction P2, is discharged at the rotary union 25 and hence at an outlet point 30 on the separating blade 1, in particular continuously (see FIG. 1). The flow path D theoretically traveled by the coolant during this process, which is provided with flow direction arrows, is illustrated in principle in FIG. 1. The flow of the coolant through the arrangement is accomplished, for example, by means of a pumping device, such as a centrifugal pump or the like.

For the support and rotary driving of the separating blade 1, the separating blade 1 has an opening 31, which is concentric with the separating blade axis S and through which a shaft section 32 of the flange arrangement 24 passes. Three axially extending, circumferentially offset recessed notches are formed on the outside of the shaft section 32, the basic shape of which is cylindrical. On the main blade 3 there is a central hole 3a matching the shaft section 32 with a shape complementary to the external shape of the shaft section 32, wherein three projections 33 that fit precisely into the notches of the shaft section 32 extend on a rim of the hole 3a, making leaktight contact. The main blade 3 thus makes fluidtight contact with the shaft section 32 over the entire circumference of the shaft section 32.

Since the two cover plates 4 and 5 each have a central circular round hole 4a and 5a, which therefore have no projections, the coolant supplied axially on the outside of the shaft section 32 at cover plate 5 can pass via the notches in the shaft section 32 into the inner volume 8 or into the partial volume 8b between cover plate 5 and the main blade 3 in the region of the round hole 5a or in the three-channel inlet point 29. Since the notches in the shaft section 32 are leaktightly closed by the projections in the main blade 3 in the inner volume 8, the shaft section 32 is sealed off with respect to the main blade 3 over its entire circumference at the associated axial point or at the outer circumference. While the separating blade 1 is rotating, the coolant is therefore guided radially outwards with the assistance of centrifugal force in partial volume 8b, at least as far as the region of the passage openings 16 to 23 in the main blade 3. The coolant then enters partial volume 8a in the axial direction through the passage openings 16 to 23 and flows back radially inwards as far as the shaft section 32. There, the notches in the shaft section 32 each form a passage or outlet in the region of the round hole 4a or the three-channel outlet point 30, thus enabling the coolant to be discharged through the flange part 26.

For the fluid-tight sealing of the inner volume 8 or of the two partial volumes 8a, 8b along the flow path D, wherein no coolant or not even a relatively small quantity of coolant, escapes outwards from the separating blade 1, there are annular or circumferentially closed seals, composed, for example, of a flexible material, radially on the outer rim of cover plate 4 and cover plate 5, in each case axially on the inside.

More specifically, there is a first seal 6 between cover plate 4 and the main blade 3 and a second seal 7 between cover plate 5 and the main blade 3. The radially inner circumferential rim of the seals 6 and 7 is in each case admittedly close to the radially outer rim of the passage openings 16 to 23, but is spaced apart therefrom at least by a safe distance.

The possibility of the radially outer rim of the cover plates 4, 5 extending as far as the machining section 2 or diamond tool 2a is not excluded. In that case, the seals 6 and 7 are preferably radially further out as far as the diamond tool 2a.

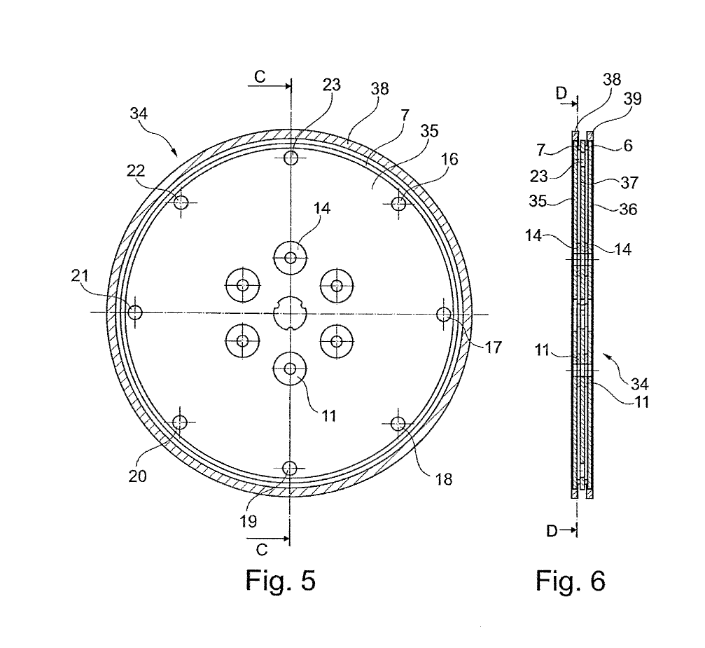

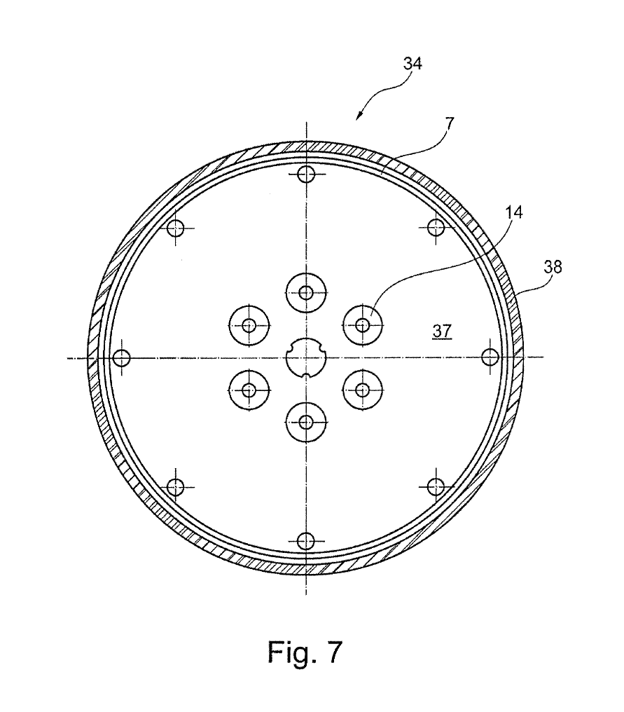

According to a second illustrative embodiment shown in FIGS. 5 to 7, an internally cooled separating blade 34 according to the present invention has two axially outer main blades 35 and 36 and an intermediate blade 37 situated axially therebetween. The separating blade 34 is configured as a double tool or as a double sawblade.

The basic structure comprising three axially spaced blades with a hollow, leaktightly closed inner volume of separating blade 34 coincides in other respects with the basic structure of separating blade 1. Especially as regards the presence of the passage openings 16-23, the through holes 15 with the spacing washers 9-14 and the seals 6 and 7.

In other words, as compared with separating blade 1, the cover plates 4, 5 on separating blade 34 are each provided with a machining section but the main blade 3 is without a machining section.

The main blades 35 and 36 each have a machining section 38 and 39, respectively, wherein the intermediate blade 37 does not have a machining section and has a diameter which is smaller than that of the two main blades 35, 36 by the radial dimension of the machining sections 38, 39.

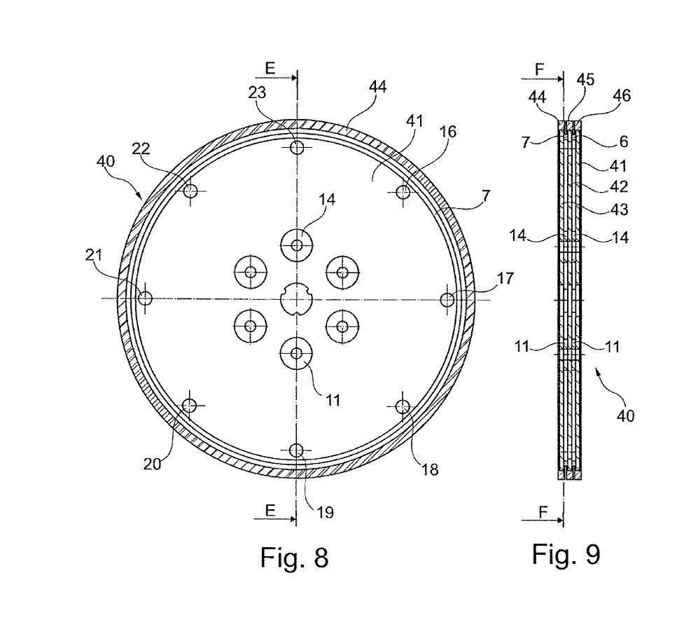

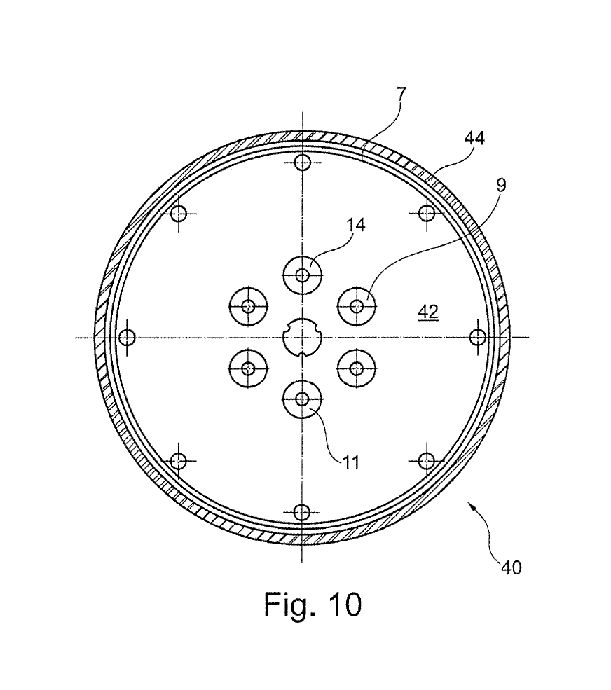

In the third illustrative embodiment of the invention shown in FIGS. 8 to 10, which shows an internally cooled triple tool or triple sawblade, the separating blade 40 according to the invention has three main blades 41, 42 and 43. The basic structure of separating blade 40 likewise corresponds to the basic structure of separating blade 1. Especially as regards the presence of the passage openings 16-23, the through holes 15 with the spacing washers 9-14 and the seals 6 and 7.

Taking separating blade 1 as a basis, all three blades in this case are provided with the same diameter and with a machining section 44, 45 and 46, respectively.

Otherwise, the two outer main blades 41 and 43 are constructed in the same way as the cover plates 4 and 5 of separating blade 1.

### List of Reference Signs:

1 separating blade
2 machining section
2a diamond tool
3 main blade
3a hole
4 cover plate
4a round hole
5 cover plate
5a round hole
6 seal
7 seal
8 inner volume
8a, 8b partial volume
9-14 spacing washer
15 through hole
16-23 passage opening
24 flange arrangement
25 rotary union
26, 27 flange part
26a, 27a seal
28 screwed joint
29 inlet point
30 outlet point
31 opening
32 shaft section
33 projection
34 separating blade
35, 36 main blade
37 intermediate blade
38, 39 machining section
40 separating blade
41-43 main blade
44-46 machining section

1. A separating blade for the material-removing machining of a mineral-containing hard material, comprising a machining section positioned radially on the outside with respect to a central separating blade axis, for material removal of the hard material, wherein the separating blade is designed to be set in rotation by a drivable flange arrangement, and wherein a liquid coolant can be supplied to the separating blade during machining, wherein, in an inner volume of the separating blade that is surrounded by parts of the separating blade, an inner structure is formed for providing a flow path, through which the coolant can flow, between an inlet point of the separating blade for supplying the coolant and an outlet point of the separating blade for the discharge of the coolant, wherein in the connected state with the flange arrangement, an outflow of portions of the supplied coolant from the inner volume is prevented along the flow path during machining using the separating blade to ensure that no coolant reaches the machining section on the outside of the separating blade.

2. The separating blade according to claim 1, wherein, in an inner volume of the separating blade that is surrounded by parts of the separating blade, an inner structure is formed for providing a flow path, through which the coolant can flow, between an inlet point of the separating blade for supplying the coolant and an outlet point of the separating blade for the discharge of the coolant, wherein the inlet point and the outlet point are in a hub region of the separating blade and wherein the inner structure defines a flow path for the coolant that can be supplied, according to which, during machining, the coolant flows radially with respect to the separating blade axis from the inside outwards from the inlet point and wherein the coolant flows radially with respect to the separating blade axis from the outside inwards to the outlet point.

3. The separating blade according to claim 1, wherein the inlet point is positioned on a first side of the separating blade, and the outlet point is situated on a second side of the separating blade, wherein the first side and the second side lie opposite one another in the axial direction with respect to the separating blade axis.

4. The separating blade according to claim 1, wherein the inlet point and the outlet point are connected to one another via the flow path for the coolant.

5. The separating blade according claim 1, further comprising guide sections formed in the inner volume for defining a flow direction of the coolant through the separating blade.

6. The separating blade according to claim 1, further comprising a seal for the fluidtight separation of the inner volume from the outside in a radially outer region of the separating blade.

7. The separating blade according to claim 5, wherein the guide sections delimit the flow path, wherein the flow path has a section with an axial extent with respect to the separating blade axis.

8. The separating blade according to claim 1, wherein the separating blade has a main blade and two outer blades, wherein the main blade is positioned between the two outer blades in the axial direction of the separating blade.

9. The separating blade according to claim 1, wherein the separating blade has a plurality of main blades and in each case one intermediate blade is positioned between two adjacent main blades.

10. The separating blade according to claim 1, wherein the separating blade has a plurality of main blades without an intermediate blade between two adjacent main blades.

11. The separating blade according to claim 1, further comprising a seal in a radially outer region of the separating blade and in an axial intermediate region between a main blade and an axially adjacent blade of the separating blade.

12. The separating blade according to claim 1, wherein the separating blade has a separating blade diameter of over 300 millimeters.

13. The separating blade according to claim 1, further comprising a spacer element between two adjacent blades of the separating blade.

14. A tool having a flange arrangement for a separating blade according to claim 1.

15. The tool according to claim 14, further comprising a liquid cooling device.

16. A separating blade for the material-removing machining of a mineral-containing hard material, comprising a machining section positioned radially on the outside with respect to a central separating blade axis, for material removal of the hard material, wherein the separating blade is designed to be set in rotation by a drivable flange arrangement, and wherein a liquid coolant can be supplied to the separating blade during machining, wherein, in an inner volume of the separating blade that is surrounded by parts of the separating blade, an inner structure is formed for providing a flow path, through which the coolant can flow, between an inlet point of the separating blade for supplying the coolant and an outlet point of the separating blade for the discharge of the coolant, wherein the inlet point and the outlet point are in a hub region of the separating blade and wherein the inner structure defines a flow path for the coolant that can be supplied, according to which, during machining, the coolant flows radially with respect to the separating blade axis from the inside outwards from the inlet point and wherein the coolant flows radially with respect to the separating blade axis from the outside inwards to the outlet point.

17. The separating blade according to claim 16, further comprising a seal for the fluidtight separation of the inner volume from the outside in a radially outer region of the separating blade.

18. The separating blade according to claim 16, wherein the separating blade has a main blade and two outer blades, wherein the main blade is positioned between the two outer blades in the axial direction of the separating blade.

19. The separating blade according to claim 16, wherein the separating blade has a plurality of main blades and in each case one intermediate blade is positioned between two adjacent main blades.

20. The separating blade according to claim 16, wherein the separating blade has a plurality of main blades without an intermediate blade between two adjacent main blades.
